(19) United States
(12) Patent Application Publication
(10) Pub. No.: US 2025/0290805 A1
(43) Pub. Date: Sep. 18, 2025

(54) SENSOR

(71) Applicant: KABUSHIKI KAISHA TOSHIBA, Tokyo (JP)

(72) Inventors: Yui YAMAZAKI, Ota Tokyo (JP); Hiroshi HAMASAKI, Hiratsuka Kanagawa (JP); Yosuke AKIMOTO, Yokohama Kanagawa (JP)

(73) Assignee: KABUSHIKI KAISHA TOSHIBA, Tokyo (JP)

(21) Appl. No.: 19/023,630

(22) Filed: Jan. 16, 2025

(30) Foreign Application Priority Data
Mar. 12, 2024 (JP) 2024-038241

(51) Int. Cl. G01K 7/16; G01K 1/02; G01K 3/14

(52) U.S. Cl. CPC G01K 7/16; G01K 1/026; G01K 3/14

(57) ABSTRACT

According to one embodiment, a sensor includes a sensor element. The sensor element includes a first element including a first detection section, and a second element including a second detection section. The first detection section includes a first resistance member and a first conductive member. The second detection section includes a second resistance member. A second temperature of the first resistance member when a first electric power is supplied to the first conductive member is higher than a first temperature. A second difference is smaller than a first difference. The first difference is an absolute value of a difference between a first change rate of a first electrical resistance of the first resistance member with respect to temperature at the first temperature and a second change rate of a second electrical resistance of the second resistance member with respect to temperature at the first temperature.

### CROSS-REFERENCE TO RELATED APPLICATIONS

This application is based upon and claims the benefit of priority from Japanese Patent Application No. 2024-038241, filed on Mar. 12, 2024; the entire contents of which are incorporated herein by reference.

### FIELD

Embodiments described herein relate generally to a sensor.

### BACKGROUND

For example, there are sensors using MEMS (Micro Electro Mechanical Systems) elements. It is desired to improve the characteristics of sensors.

### BRIEF DESCRIPTION OF THE DRAWINGS

FIG. 1 is a schematic cross-sectional view illustrating a sensor according to a first embodiment;

FIGS. 2A and 2B are schematic plan views illustrating the sensor according to the first embodiment;

FIGS. 3A and 3B are schematic plan views illustrating the sensor according to the first embodiment;

FIG. 4 is a schematic cross-sectional view illustrating a sensor according to the second embodiment;

FIGS. 5A and 5B are schematic plan views illustrating a part of the sensor according to the second embodiment;

FIG. 6 is a schematic cross-sectional view illustrating a sensor according to the third embodiment; and

FIGS. 7A and 7B are schematic diagrams illustrating the sensor according to the embodiment.

### DETAILED DESCRIPTION

According to one embodiment, a sensor includes a sensor element. The sensor element includes a first element including a first detection section, and a second element including a second detection section. The first detection section includes a first resistance member and a first conductive member. The second detection section includes a second resistance member. A second temperature of the first resistance member when a first electric power is supplied to the first conductive member is higher than a first temperature. A second difference is smaller than a first difference. The first difference is an absolute value of a difference between a first change rate of a first electrical resistance of the first resistance member with respect to temperature at the first temperature and a second change rate of a second electrical resistance of the second resistance member with respect to temperature at the first temperature. The second difference is an absolute value of a difference between a second temperature state change rate of the first electrical resistance of the first resistance member with respect to temperature at the second temperature and the second change rate.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

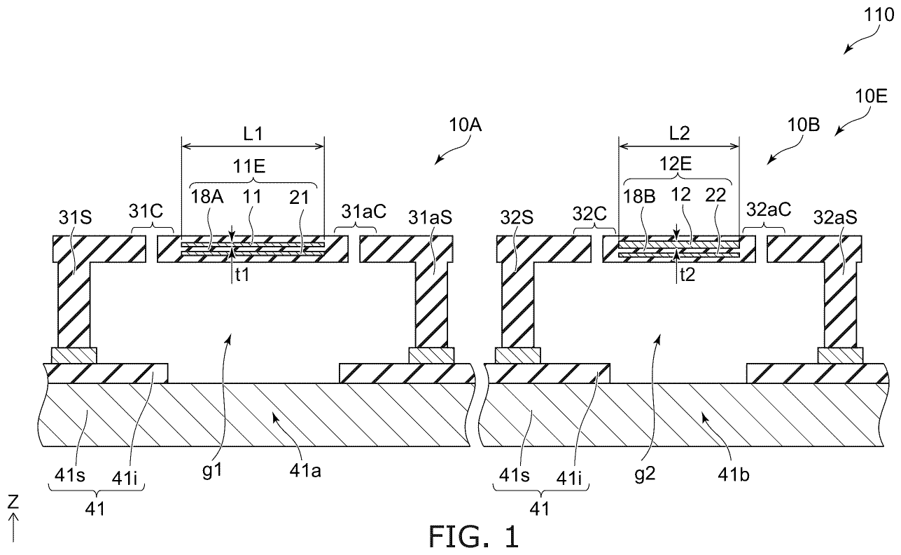

FIG. 1 is a schematic cross-sectional view illustrating a sensor according to a first embodiment.

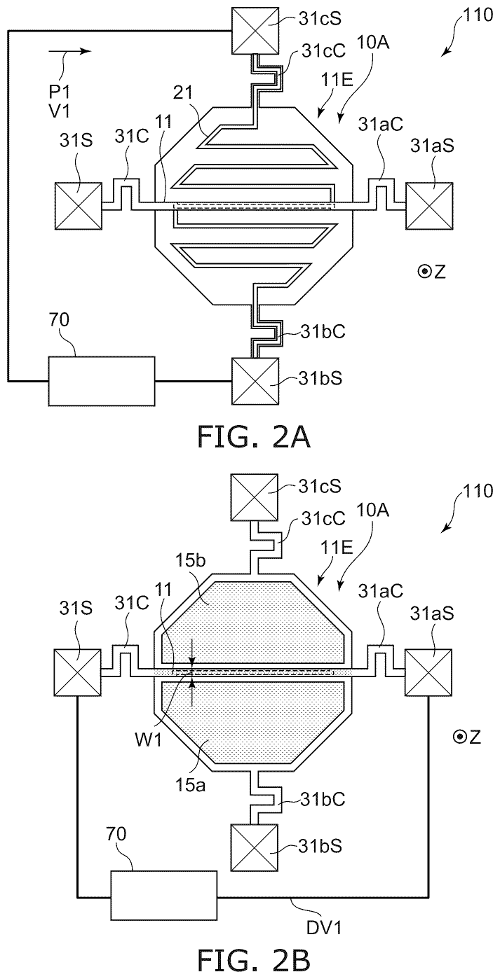

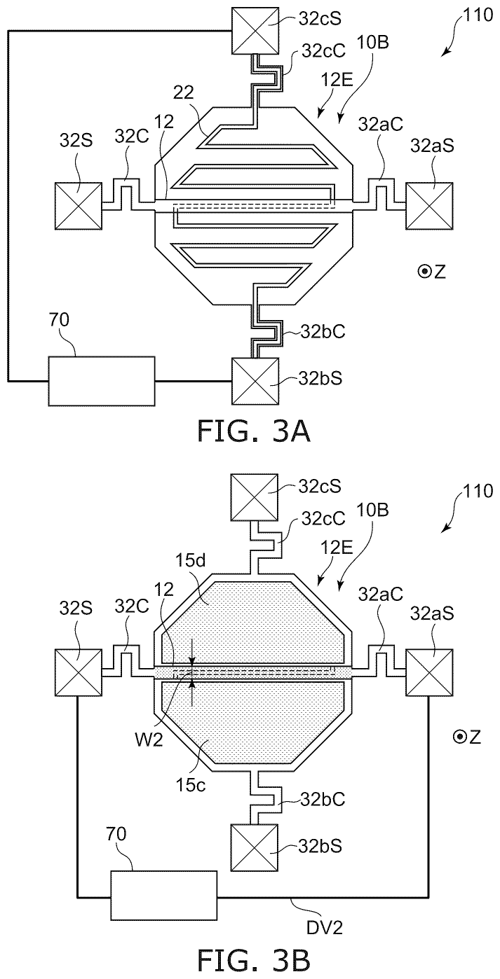

FIGS. 2A, 2B, 3A, and 3B are schematic plan views illustrating the sensor according to the first embodiment.

As shown in FIG. 1, a sensor 110 according to the embodiment includes a sensor element 10E. The sensor element 10E includes a first element 10A and a second element 10B. The first element 10A includes a first detection section 11E. The second element 10B includes a second detection section 12E.

The first detection section 11E includes a first resistance member 11 and a first conductive member 21. The second detection section 12E includes a second resistance member 12.

The second detection section 12E may include a second conductive member 22.

FIG. 2A is a plan view of a plane including the first conductive member 21. FIG. FIG. 2B is a plan view of a plane including the first resistance member 11. FIG. 3A is a plan view of a plane including the second conductive member 22. FIG. 3B is a plan view of a plane including the second resistance member 12.

As shown in FIGS. 2A, 2B, 3A, and 3B, in the embodiment, the sensor 110 may include a controller 70. The controller 70 may be provided separately from the sensor 110.

For example, a first electric power P1 is supplied to the first conductive member 21. For example, the first electric power P1 is supplied to the first conductive member 21 from the controller 70. The temperature of the first conductive member 21 rises based on the first electric power P1 (voltage V1). The temperature rise is based on Joule heat, for example. As the temperature of the first conductive member 21 rises, the temperature of the first detection section 11E rises.

The temperature before the rising is defined as a first temperature T1. A second temperature T2 of the first resistance member 11 when the first electric power P1 is supplied to the first conductive member 21 is higher than the first temperature T1. The first temperature T1 may be, for example, the temperature of the first resistance member 11 when the first electric power P1 is not supplied to the first conductive member 21.

A first electrical resistance of the first resistance member 11 changes depending on the temperature of the first detection section 11E (first resistance member 11). As described above, the temperature of the first resistance member 11, which rises by the first electric power P1, changes depending on a detection target (for example, detection target gas) existing around the first element 10A. For example, the degree of heat radiation in the first detection section 11E changes depending on the concentration of the detection target gas. For example, the degree of heat radiation changes depending on the type of the detection target gas. Therefore, the temperature of the first resistance member 11 depends on the detection target. The first electrical resistance of the first resistance member 11 changes depending on the detection target. By detecting the first electrical resistance, information regarding the detection target can be obtained. The sensor 110 is, for example, a thermally conductive gas sensor.

The detection target may include, for example, at least one selected from the group consisting of carbon dioxide, hydrogen, nitrogen, and carbon monoxide.

In the embodiment, the detection value of the first electrical resistance of the first resistance member 11 is corrected by a detection value of the second electrical resistance of the second resistance member 12. By the correction, the detection target can be detected with higher accuracy.

For example, the first electrical resistance of the first resistance member 11 changes depending on the temperature around the sensor 110. For example, the influence of ambient temperature is suppressed by correction based on the detection value of the second electrical resistance of the second resistance member 12.

In one example, the first electric power P1 is not supplied to the second conductive member 22. Alternatively, the second conductive member 22 is not provided in the second detection section 12E.

The first temperature T1 is lower than the second temperature T2 when rises. The first temperature T1 is, for example, room temperature. The second temperature T2 is, for example, a high temperature. The change rate of the electrical resistance of the resistance member with respect to temperature changes depending on the temperature.

In the embodiment, an absolute value of a difference between a first change rate of the first electrical resistance of first resistance member 11 with respect to temperature at the first temperature T1 and a second change rate of the second electrical resistance of the second resistance member 12 with respect to temperature at the first temperature T1 is defined as a first difference Δ1.

An absolute value of a difference between the second change rate and a second temperature state change rate with respect to the temperature of the first electrical resistance of the first resistance member 11 at the second temperature T2 is defined as a second difference Δ2.

In the embodiment, the second difference Δ2 is set smaller than the first difference Δ1. Thereby, for example, correction with higher accuracy can be possible. The detection targets can be detected with higher accuracy, for example. A higher S/N ratio can be obtained. According to the embodiment, for example, a sensor whose characteristics can be improved can be provided.

For example, in a reference example, the second electrical resistance of the second resistance member 12 is set to be substantially the same as the first electrical resistance of the first resistance member 11 at the first temperature T1 (room temperature). In the reference example, the change rate of the electrical resistance of the first resistance member 11 with respect to temperature at the second temperature T2 being high often does not match the change rate of the electrical resistance of the second resistance member 12 with respect to temperature at the first temperature T1 being room temperature. In the reference example, the accuracy of correction is insufficient.

In the embodiment, the second difference Δ2 is set smaller than the first difference Δ1. This provides highly accurate correction.

The embodiment, a first electrical resistance value of the first resistance member 11 at the first temperature T1 may be different from a second electrical resistance value of the second resistance member 12 at the first temperature T1. For example, the second electrical resistance value is set lower than the first electrical resistance value. This makes it easy to obtain the second difference Δ2 being small.

In the embodiment, the second electrical resistance value of the second resistance member 12 at the first temperature T1 may be not less than 0.3 times and not more than 0.95 times the first electrical resistance value of the first resistance member 11 at the first temperature T1.

The first electrical resistance value of the first resistance member 11 at the first temperature T1 may be, for example, not less than 6 kΩ and not more than 12 kΩ. The second electrical resistance value of the second resistance member 12 at the first temperature T1 is, for example, not less than 1.8 kΩ and not more than 12 kΩ.

In the embodiment, the first temperature T1 may be, for example, not less than −10° C. and not more than 80° C. As already explained, the second temperature T2 is higher than the first temperature T1. The absolute value of the difference between the second temperature T2 and the first temperature T1 may be, for example, not less than 30° C. and not more than 300° C.

The ratio of the absolute value of the difference between the second difference Δ2 and the first difference Δ1 to the first difference Δ1 may be, for example, 0.5 or more. The ratio may be, for example, 1 or less. Highly accurate correction is possible.

For example, the controller 70 may be configured to perform the following first operation. In the first operation, the controller 70 supplies the first electric power P1 to the first conductive member 21. In the first operation, the controller 70 is configured to detect a difference between a first detection value DV1 (see FIG. 2B) of the first electrical resistance of the first resistance member 11 in the first operation and a second detection value DV2 (see FIG. 3B) of the second electrical resistance of the second resistance member 12 in the first operation. The first detection value DV1 corresponds to the detection target around the first detection section 11E. The first detection value DV1 is corrected by the second detection value DV2.

For example, the first detection value DV1 and the second detection value DV2 may be input to a differential circuit included in the controller 70. The output of the differential circuit may be employed as the detection result of the detection target.

As shown in FIG. 1, the first element 10A may include a first base region 41a, a first fixed portion 31S, and a first support portion 31C. The first fixed portion 31S is fixed to a part of the first base region 41a. The first support portion 31C is supported by the first fixed portion 31S. The first support portion 31C supports the first detection section 11E. A first gap g1 is provided between another part of the first base region 41a and the first detection section 11E.

In this example, the first element 10A further includes a first opposing fixed portion 31aS and a first opposing support portion 31aC. The first opposing fixed portion 31aS is fixed to another part of the first base region 41a. The first opposing support portion 31aC is supported by the first opposing fixed portion 31aS. The first opposing support portion 31aC supports the first detection section 11E. For example, the first detection section 11E is provided between the first support portion 31C and the first opposing support portion 31aC.

As shown in FIGS. 2A and 2B, the first element 10A may include a first cross fixed portion 31bS, a first cross support portion 31bC, a first cross opposing fixed portion 31cS, and a first cross opposing support portion 31cC. The first cross fixed portion 31bS is fixed to another part of the first base region 41a. The first cross support portion 31bC is supported by the first cross fixed portion 31bS. The first cross support portion 31bC supports the first detection section 11E.

The first cross fixed portion 31cS is fixed to another part of the first base region 41a. The first cross support portion 31cC is supported by the first cross opposing fixed portion 31cS. The first cross-opposing support portion 31cC supports the first detection section 11E.

A direction from a part of the first base region 41a to the first fixed portion 31S is defined as a Z-axis direction (first direction). A direction from the first support portion 31C to the first opposing support portion 31aC cross the Z-axis direction. A direction from the first cross support portion 31bC to the first cross opposing support portion 31cC crosses the Z-axis direction.

A direction from the first cross support portion 31bC to the first cross opposing support portion 31cC crosses the direction from the first support portion 31C to the first opposing support portion 31aC.

At least one of the first support portion 31C, the first opposing support portion 31aC, the first cross support portion 31bC, or the first cross support portion 31cC may have a meander structure.

As shown in FIG. 1, the second element 10B may include a second base region 41b, a second fixed portion 32S, and a second support portion 32C. The second fixed portion 32S is fixed to a part of the second base region 41b. The second support portion 32C is supported by the second fixed portion 32S. The second support portion 32C supports the second detection section 12E. A second gap g2 is provided between another part of the second base region 41b and the second detection section 12E.

In this example, the second element 10B further includes a second opposing fixed portion 32aS and a second opposing support portion 32aC. The second opposing fixed portion 32aS is fixed to another part of the second base region 41b. The second opposing support portion 32aC is supported by the second opposing fixed portion 32aS. The second opposing support portion 32aC supports the second detection section 12E. For example, the second detection section 12E is provided between the second support portion 32C and the second opposing support portion 32aC.

As shown in FIGS. 3A and 3B, the second element 10B may include a second cross fixed portion 32bS, a second cross support portion 32bC, a second cross opposing fixed portion 32cS, and a second cross opposing support portion 32cC. The second cross fixed portion 32bS is fixed to another part of the second base region 41b. The second cross support portion 32bC is supported by the second cross fixed portion 32bS. The second cross support portion 32bC supports the second detection section 12E.

The second cross opposing fixed portion 32cS is fixed to another part of the second base region 41b. The second cross support portion 32cC is supported by the second cross opposing fixed portion 32cS. The second cross-opposing support portion 32cC supports the second detection section 12E.

A direction from the part of the second base region 41b to the second fixed portion 32S may be along the Z-axis direction.

A direction from the second support portion 32C to the second opposing support portion 32aC crossing the direction from a part of the second base region 41b to the second fixed portion 32S.

A direction from the second cross support portion 32bC to the second cross opposing support portion 32cC crosses the direction from a part of the second base region 41b to the second fixed portion 32S. A direction from the second cross support portion 32bC to the second cross opposing support portion 32cC crosses the direction from the second support portion 32C to the second opposing support portion 32aC.

At least one of the second support portion 32C, the second opposing support portion 32aC, the second cross support portion 32bC, or the second cross opposing support portion 32cC may have a meander structure.

As shown in FIG. 1, the first base region 41a is a part of the base 41. The second base region 41b may be another part of the base 41. The first base region 41a may be one base 41, and the second base region 41b may be another base.

In this example, the base 41 may include a substrate 41s and an insulating layer 41i. The insulating layer 41i is provided on the substrate 41s. The substrate 41s includes a semiconductor substrate or the like. The substrate 41s may include a part of the circuit included in the controller 70.

As shown in FIG. 1, the first detection section 11E may include a first insulating member 18A. The first insulating member 18A is provided around the first resistance member 11 and the first conductive member 21. The second detection section 12E may include a second insulating member 18B. The second insulating member 18B is provided around the second resistance member 12. The second insulating member 18B may be provided around the second conductive member 22.

In the embodiment, the first resistance member 11 and the second resistance member 12 may satisfy at least one of a first condition, a second condition, and a third condition.

As shown in FIG. 1, in the first condition, a first length L1 of the first resistance member 11 is different from a second length L2 of the second resistance member 12.

As shown in FIGS. 2B and 3B, in the second condition, a first width W1 of the first resistance member 11 is different from a second width W2 of the second resistance member 12.

As shown in FIG. 1, in the third condition, a first thickness t1 of the first resistance member 11 is different from a second thickness t2 of the second resistance member 12.

Due to at least one of the first to third conditions, it becomes easy to obtain the second difference Δ2 being small.

For example, in the first condition, the first length L1 may be longer than the second length L2. For example, in the second condition, the first width W1 may be smaller than the second width W2. For example, in the third condition, the first thickness t1 is thinner than the second thickness t2. It becomes easy to obtain the second difference Δ2 being small.

In the first to third conditions above, a material of the first resistance member 11 may be the same as a material of the second resistance member 12. Based on the same material, manufacturing is easy. For example, at least one of the first resistance member 11 and the second resistance member 12 may include TiN.

A first material of the first resistance member 11 may be different from a second material of the second resistance member 12. Thereby, it becomes easier to obtain the second difference Δ2 being small.

In the embodiment, a first temperature coefficient of resistance of the first resistance member 11 may be either positive or negative. A second temperature coefficient of resistance of the second resistance member 12 may be either positive or negative. It becomes easy to obtain the second difference Δ2 being small.

For example, the first resistance member 11 includes at least one selected from the group consisting of Ti, TiN, Pt, Au, and A1. The second resistance member 12 includes at least one selected from the group consisting of Ti, TiN, Pt, Au, and A1. In one example, first resistance member 11 includes TiN and second resistance member 12 includes Ti.

In the sensor 110, the first resistance member 11 may be one of the plurality of resistance elements included in the bridge circuit. The second resistance member 12 may be another one of the plurality of resistance elements included in the bridge circuit. As described later, the bridge circuit may be, for example, a quarter bridge circuit. The bridge circuit may be, for example, a half-bridge circuit.

As shown in FIG. 2B, the first detection section 11E may include a first conductive layer 15a and a second conductive layer 15b. The first resistance member 11 is provided between the first conductive layer 15a and the second conductive layer 15b.

As shown in FIG. 3B, the second detection section 12E may include a third conductive layer 15c and a fourth conductive layer 15d. The second resistance member 12 is provided between the third conductive layer 15c and the fourth conductive layer 15d.

### Second Embodiment

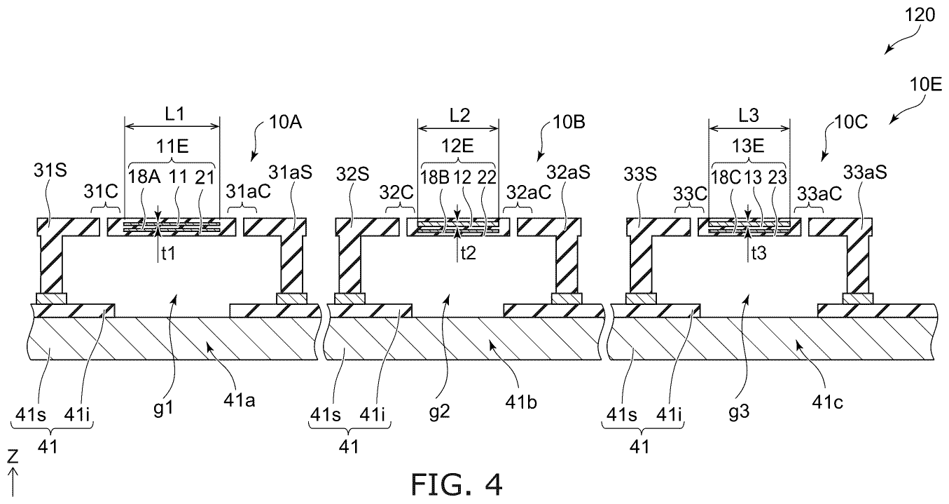

FIG. 4 is a schematic cross-sectional view illustrating a sensor according to the second embodiment.

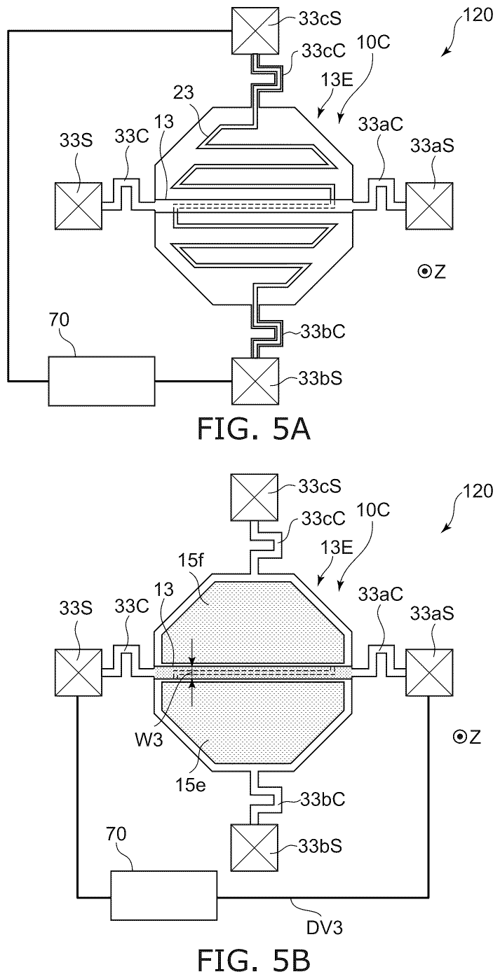

FIGS. 5A and 5B are schematic plan views illustrating a part of the sensor according to the second embodiment.

As shown in FIG. 4, in a sensor 120 according to the embodiment, the sensor element 10E further includes a third element 10C in addition to the first element 10A and the second element 10B. The configuration of the sensor 120 except for this may be the same as the configuration of the sensor 110.

The third element 10C includes a third detection section 13E. The third detection section 13E includes a third resistance member 13. A third temperature T3 of the first resistance member 11 when the second electric power is supplied to the first conductive member 21 is higher than the first temperature T1.

The third temperature T3 may be different from the second temperature T2 described above.

As described above, a change rate of the first electrical resistance of the first resistance member 11 with respect to temperature at the first temperature T1 is the first change rate. On the other hand, a change rate of the third electrical resistance of the third resistance member 13 at the first temperature T1 with respect to temperature is defined as a third change rate. An absolute value of a difference between the first change rate and the third change rate is defined as a third difference Δ3.

A change rate of the first electrical resistance of the first resistance member 11 at the third temperature T3 with respect to temperature is defined as a third temperature state change rate. An absolute value of a difference between the third temperature state change rate and the third change rate is defined as a fourth difference Δ4. In the embodiment, the fourth difference Δ4 is smaller than the third difference Δ3.

Thereby, for example, the detection value of the first electrical resistance of the first resistance member 11 is corrected with high accuracy by the detection value of the third electrical resistance of the third resistance member 13. By the correction, the detection target can be detected with higher accuracy.

In the sensor 120, for example, the first electrical resistance value of the first resistance member 11 at the first temperature T1 is different from the second electrical resistance value of the second resistance member 12 at the first temperature T1. For example, the first electrical resistance value is different from a third electrical resistance value of the third resistance member 13 at the first temperature T1. For example, the second electrical resistance value may be different from the third electrical resistance value.

For example, the second electrical resistance value may be lower than the first electrical resistance value. For example, the third electrical resistance value may be lower than the first electrical resistance value.

In the sensor 120, at least one of correction using the second element 10B or correction using the third element 10C may be performed.

The sensor 120 may further include the controller 70 (see FIGS. 5A, 5C, etc.). The controller 70 is configured to perform at least one of the first operation or a second operation. The first operation may be the operation described regarding the sensor 110.

In the first operation, the controller 70 supplies the first electric power P1 to the first conductive member 21. In the first operation, the controller 70 detects the first detection value DV1 of the first electrical resistance of the first resistance member 11 in the first operation (see FIG. 2B) and the first detection value DV1 of the first electrical resistance of the first resistance member 11 in the first operation. A difference between the second detection value DV2 (see FIG. 3B) of the second electrical resistance is detected. The first detection value DV1 depends on the detection target around the first detection section 11E.

In the second operation, the controller 70 supplies the second electric power to the first conductive member 21. In the second operation, the controller 70 detects a difference between the first detection value DV1 of the first electrical resistance of the first resistance member 11 in the second operation and a third detection value DV3 (see FIG. 5B) of the third electrical resistance of the third resistance member 13 in the second operation. Also in the second operation, the first detection value DV1 corresponds to the detection target.

The third detection section 13E of the third element 10C may include a third conductive member 23. FIG. 5A is a plan view of a plane including the third conductive member 23. FIG. 5B is a plan view of a plane including the third resistance member 13.

As shown in FIG. 4, the third element 10C may include a third base region 41c, a third fixed portion 33S, and a third support portion 33C. The third fixed portion 33S is fixed to a part of the third base region 41c. The third support portion 33C is supported by the third fixed portion 33S. The third support portion 33C supports the third detection section 13E. A third gap g3 is provided between another part of the third base region 41c and the third detection section 13E.

In this example, the third element 10C further includes a third opposing fixed portion 33aS and a third opposing support portion 33aC. The third opposing fixed portion 33aS is fixed to another part of the third base region 41c. The third opposing support portion 33aC is supported by the third opposing fixed portion 33aS. The third opposing support portion 33aC supports the third detection section 13E. For example, the third detection section 13E is provided between the third support portion 33C and the third opposing support portion 33aC.

As shown in FIGS. 5A and 5B, the third element 10C may include a third cross fixed portion 33bS, a third cross support portion 33bC, a third cross opposing fixed portion 33cS, and a third cross opposing support portion 33cC. The third cross fixed portion 33bS is fixed to another part of the third base region 41c. The third cross support portion 33bC is supported by the third cross fixed portion 33bS. The third cross support portion 33bC supports the third detection section 13E.

The third cross fixed portion 33cS is fixed to another part of the third base region 41c. The third cross opposing support portion 33cC is supported by the third cross opposing fixed portion 33cS. The third cross opposing support portion 33cC supports the third detection section 13E.

A direction from a part of the third base region 41c to the third fixed portion 33S may be along the Z-axis direction. A direction from the third support portion 33C to the third opposing support portion 33aC crosses the direction from a part of the third base region 41c to the third fixed portion 33S. A direction from the third cross support portion 33bC to the third cross opposing support portion 33cC crosses the direction from a part of the third base region 41c to the third fixed portion 33S. A direction from the third cross support portion 33bC to the third cross opposing support portion 33cC crosses the direction from the third support portion 33C to the third opposing support portion 33aC.

At least one of the third support portion 33C, the third opposing support portion 33aC, the third cross support portion 33bC, and the third cross support portion 33cC may have a meander structure.

As shown in FIG. 4, the third detection section 13E may include a third insulating member 18C. The third insulating member 18C is provided around the third resistance member 13 and the third conductive member 23.

In the embodiment, the first resistance member 11 and the third resistance member 13 may satisfy at least one of a fourth condition, a fifth condition, and a sixth condition.

In the fourth condition, the first length L1 of the first resistance member 11 is different from a third length L3 of the third resistance member 13 (see FIG. 4).

In the fifth condition, the first width W1 of the first resistance member 11 is different from a third width W3 of the third resistance member 13 (see FIG. 5B).

In the sixth condition, the first thickness t1 of the first resistance member 11 is different from a third thickness t3 of the third resistance member 13 (see FIG. 4).

Due to at least one of the fourth to sixth conditions, it becomes easy to obtain the fourth difference Δ4 being small.

For example, in the fourth condition, the first length L1 may be longer than the third length L3. For example, in the fifth condition, the first width W1 may be smaller than the third width W3. For example, in the sixth condition, the first thickness t1 may be thinner than the third thickness t3. It becomes easy to obtain the fourth difference Δ4 being small.

In the fourth to sixth conditions above, the material of the first resistance member 11 may be the same as a material of the third resistance member 13. Based on the same material, manufacturing is easy. For example, at least one of the first resistance member 11 and the third resistance member 13 may include TiN.

The first material of the first resistance member 11 may be different from the third material of the third resistance member 13. Thereby, it becomes easier to obtain the fourth difference Δ4 being small.

As shown in FIG. 5B, the third detection section 13E may include a fifth conductive layer 15e and a sixth conductive layer 15f. The third resistance member 13 is provided between the fifth conductive layer 15e and the sixth conductive layer 15f.

### Third Embodiment

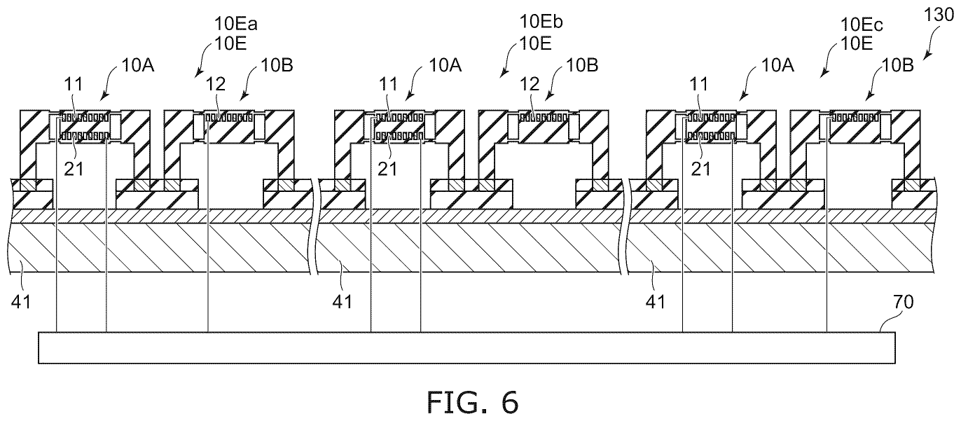

FIG. 6 is a schematic cross-sectional view illustrating a sensor according to the third embodiment.

As shown in FIG. 6, a sensor 130 according to the embodiment includes a plurality of sensor elements 10E. The sensor 130 may further include the controller 70. The plurality of sensor elements 10E may include, for example, an element 10Ea, an element 10Eb, an element 10Ec, and the like. Each of the plurality of sensor elements 10E may have the configuration of the sensor element 10E in the sensor 110, for example. For example, the second difference Δ2 is smaller than the first difference Δ1.

In the sensor 130, the controller 70 may be configured to perform at least one of a first detection operation and a second detection operation.

In the first detection operation, the controller 70 supplies the first electric power P1 in the first detection operation to the first conductive member 21 included in one (for example, the element 10Ea) of the plurality of sensor elements 10E. The controller 70 detects a first value corresponding to a difference between the electrical resistance of the first resistance member 11 included in the one of the plurality of sensor elements and the electrical resistance of the second resistance member 12 included in the one of the plurality of sensor elements 10E. For example, the operation described with respect to the sensor 110 is performed.

In the second detection operation, the controller 70 supplies the first electric power P1 in the second detection operation to the first conductive member 21 included in another one of the plurality of sensor elements 10E. The controller 70 detects a second value corresponding to a difference between the electrical resistance of the first resistance member 11 included in the other one of the plurality of sensor elements 10E and the electrical resistance of the second resistance member 12 included in the other one of the plurality of sensor elements 10E.

For example, the first electric power P1 in the first detection operation is different from the first electric power P1 in the second detection operation. For example, by processing the first value and the second value, for example, the concentrations of a plurality of types of target substances included in the target gas may be detected. For example, there may be simultaneous equations representing the relationship between the concentrations of multiple types of objects and the detection values. The above-described processing regarding the first value and the second value may include an operation for finding a solution to simultaneous equations.

In the embodiment, the controller 70 may be configured to output a value obtained by calculation based on the first value and the second value. This value obtained by the calculation may include a value corresponding to each concentration of a plurality of types of detection target substances included in the detection target.

In the embodiment, the electrical resistance of the first conductive member 21 included in one of the plurality of sensor elements 10E (for example, the element 10Ea) may be different from the electrical resistance of the first conductive member 21 included in another one of the plurality of sensor elements 10E (for example, the element 10Eb). The voltage applied to the first conductive member 21 included in one of the plurality of sensor elements 10E (for example, the element 10Ea) may be the same as the voltage applied to the first conductive member 21 included in another one of the plurality of sensor elements 10E (for example, the element 10Eb). The electric power supplied to the first conductive member 21 included in one of the plurality of sensor elements 10E is different from the electric power supplied to the first conductive member 21 included in another one of the plurality of sensor elements 10E.

The number of the plurality of sensor elements 10E may be three. In this case, the controller 70 may be configured to perform at least one of the first detection operation, the second detection operation, or the third detection operation. The number of the plurality of sensor elements 10E may be four or more. The number of the plurality of sensor elements 10E may be set according to the number of types of the plurality of detection substances included in the detection target.

In the embodiment, the electrical resistance of the first conductive member 21 included in still another one (for example, the element 10Ec) of the plurality of sensor elements 10E may be different from the electrical resistance of the first conductive member 21 included in one (for example, the element 10Ea) of the plurality of sensor elements 10E. The electrical resistance of the first conductive member 21 included in still another one (for example, the element 10Ec) of the plurality of sensor elements 10E may be different from the electrical resistance of the first conductive member 21 included in another one (for example, the element 10Eb) of the plurality of sensor elements 10E.

The voltage applied to the first conductive member 21 included in one of the plurality of sensor elements 10E (for example, the element 10Ea) may be the same as the voltage applied to the first conductive member 21 included in another one of the plurality of sensor elements 10E (for example, the element 10Eb). The voltage applied to the first conductive member 21 included in one of the plurality of sensor elements 10E (for example, the element 10Ea) may be the same as the voltage applied to the first conductive member 21 included in still another one of the plurality of sensor elements 10E (for example, the element 10Ec). The same voltage may be applied to these three elements.

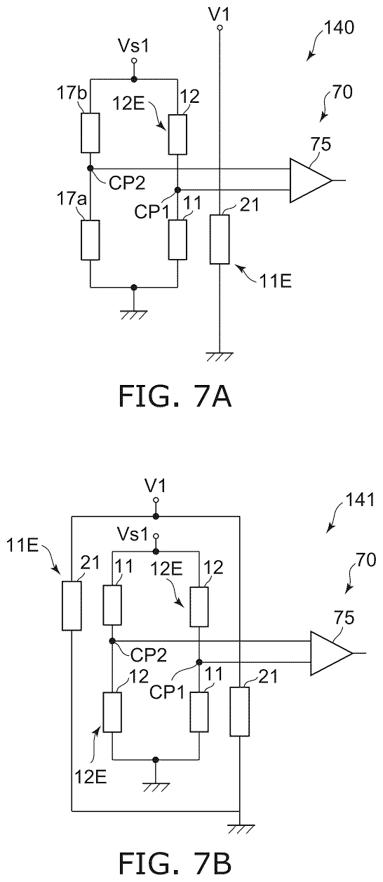

FIGS. 7A and 7B are schematic diagrams illustrating the sensor according to the embodiment.

As shown in FIG. 7A, a sensor 140 according to the embodiment includes a first resistance member 11, a second resistance member 12, a first resistance element 17a, and a second resistance element 17b. The first resistance member 11 and the second resistance member 12 may have the configuration described with respect to the sensor 110. For example, the resistance value of the first resistance element 17a and the resistance value of the second resistance element 17b may be substantially the same as the resistance value of the second resistance member 12.

The second resistance member 12 is electrically connected in series with the first resistance member 11. The second resistance element 17b is electrically connected in series with the first resistance element 17a. A circuit including the first resistance member 11 and the second resistance member 12 is electrically connected in parallel with a circuit including the first resistance element 17a and the second resistance element 17b.

A voltage V1 is applied to the first conductive member 21. For example, an end of the first resistance member 11 and an end of the first resistance element 17a are set to the ground potential. For example, a detection voltage Vs1 is applied to an end of the second resistance member 12 and an end of the second resistance element 17b. A first potential at a first connection point CP1 between the first resistance member 11 and the second resistance member 12 and a second potential at a second connection point CP2 between the first resistance element 17a and the second resistance element 17b are input to a differential circuit 75. The output of the differential circuit 75 corresponds to the detection result of the detection target. The differential circuit 75 may be included in the controller 70.

As shown in FIG. 7B, the sensor 141 according to the embodiment includes two first resistance members 11, two second resistance members 12, and two first conductive members 21. Each of the two first resistance members 11 and each of the two second resistance members 12 may have the configuration described regarding the sensor 110.

A voltage V1 is applied to the two first conductive members 21. In this example, one of the two first resistance members 11 is electrically connected in series with one of the two second resistance members 12. Another one of the two first resistance members 11 is electrically connected in series with another one of the two second resistance members 12. A first circuit including one of the two first resistance members 11 and one of the two second resistance members 12 is electrically connected in parallel with a second circuit including another one of the two first resistance members 11 and another one of the two second resistance members 12.

One end of the two first resistance members 11 and another end of the two second resistance members 12 are set to the ground potential. The detection voltage Vs1 is applied to another end of the two first resistance members 11 and one end of the two second resistance members 12. A first potential of the first connection point CP1 of one of the two first resistance members 11 and one of the two second resistance members 12 and a second potential of the second connection point CP2 of another one of the two second resistance members 12 and another one of the two first resistance members 11 are input to the differential circuit 75. The output of the differential circuit 75 corresponds to the detection result of the detection target.

In the embodiment, the first resistance member 11 may be one of a plurality of resistance elements included in the bridge circuit. The second resistance member 12 may be another one of the plurality of resistance elements included in the bridge circuit.

The embodiments may include the following Technical proposals:

(Technical proposal 1)

A sensor, comprising:
a sensor element including:
   a first element including a first detection section, and
   a second element including a second detection section,
the first detection section including a first resistance member and a first conductive member,
the second detection section including a second resistance member,
a second temperature of the first resistance member when a first electric power being supplied to the first conductive member being higher than a first temperature;
a second difference being smaller than a first difference,
the first difference being an absolute value of a difference between a first change rate of a first electrical resistance of the first resistance member with respect to temperature at the first temperature and a second change rate of a second electrical resistance of the second resistance member with respect to temperature at the first temperature, and
the second difference being an absolute value of a difference between a second temperature state change rate of the first electrical resistance of the first resistance member with respect to temperature at the second temperature and the second change rate.
   (Technical proposal 2)

The sensor according to Technical proposal 1, wherein
a first electrical resistance value of the first resistance member at the first temperature is different from a second electrical resistance value of the second resistance member at the first temperature.
   (Technical proposal 3)

The sensor according to Technical proposal 2, wherein
the second electrical resistance value is lower than the first electrical resistance value.
   (Technical proposal 4)

The sensor according to Technical proposal 2, wherein
the second electrical resistance value is not less than 0.3 times and not more than 0.95 times the first electrical resistance value.
   (Technical proposal 5)

The sensor according to any one of Technical proposals 2-4, wherein
the first electrical resistance value is not less than 6 kΩ and not more than 12 kΩ, and
the second electrical resistance value is not less than 1.8 kΩ and not more than 12 kΩ.
   (Technical proposal 6)

The sensor according to any one of Technical proposals 1-5, wherein
the first temperature is not less than −10° C. and not more than 80° C., and
an absolute value of a difference between the second temperature and the first temperature is not less than 30° C. and not more than 300° C.
   (Technical proposal 7)

The sensor according to any one of Technical proposals 1-6, wherein
a ratio of an absolute value of a difference between the second difference and the first difference to the first difference is 0.5 or more.
   (Technical proposal 8)

The sensor according to any one of Technical proposals 1-7, wherein
the second detection section further includes a second conductive member.
   (Technical proposal 9)

The sensor according to any one of Technical proposals 1-8, further comprising:
a controller,
the controller being configured to perform a first operation,
in the first operation, the controller being configured to supply the first electric power to the first conductive member,
in the first operation, the controller being configured to detect a difference between a first detection value of the first electrical resistance of the first resistance member in the first operation and a second detection value of the second electrical resistance of the second resistance member in the first operation, and
the first detection value being configured to correspond to a detection target around the first detection section.
   (Technical proposal 10)

The sensor according to any one of Technical proposals 1-9, wherein
at least one of the first resistance member or the second resistance member includes TiN.
   (Technical proposal 11)

The sensor according to any one of Technical proposals 1-10, wherein
the first resistance member and the second resistance member satisfy at least one of a first condition, a second condition, or a third condition,
in the first condition, a first length of the first resistance member is different from a second length of the second resistance member,
in the second condition, a first width of the first resistance member is different from a second width of the second resistance member, and
in the third condition, a first thickness of the first resistance member is different from a second thickness of the second resistance member.
   (Technical proposal 12)

The sensor according to Technical proposal 11, wherein
in the first condition, the first length is longer than the second length,
in the second condition, the first width is smaller than the second width, and
in the third condition, the first thickness is smaller than the second thickness.
   (Technical proposal 13)

The sensor according to Technical proposal 1, wherein
the sensor element further includes a third element including a third detection section,
the third detection section includes a third resistance member,
a third temperature of the first resistance member when a second electric power is supplied to the first conductive member is higher than the first temperature,
a fourth difference is smaller than a third difference,
the third difference is an absolute value of a difference between the first change rate and a third change rate of a third electrical resistance of the third resistance member at the first temperature with respect to temperature, and
the fourth difference is an absolute value of a difference between a third temperature state change rate of the first electrical resistance of the first resistance member with respect to temperature at the third temperature and the third change rate.
   (Technical proposal 14)

The sensor according to Technical proposal 13, wherein
a first electrical resistance value of the first resistance member at the first temperature is different from a second electrical resistance value of the second resistance member at the first temperature,
the first electrical resistance value is different from a third electrical resistance value of the third resistance member at the first temperature, and
the second electrical resistance value is different from the third electrical resistance value.
   (Technical proposal 15)

The sensor according to Technical proposal 13 or 14, further comprising:
a controller,
the controller being configured to perform at least one of a first operation or a second operation,
in the first operation, the controller being configured to supply the first electric power to the first conductive member,
in the first operation, the controller being configured to detect a difference between a first detection value of the first electrical resistance of the first resistance member in the first operation and a second detection value of the second electrical resistance of the second resistance member in the first operation,
the first detection value being configured to correspond to a detection target around the first detection section,
in the second operation, the controller being configured to supply the second electric power to the first conductive member, and
in the second operation, the controller being configured to detect a difference between the first detection value of the first electrical resistance of the first resistance member in the second operation and a third detection value of the third electrical resistance of the third resistance member in the second operation.
   (Technical proposal 16)

The sensor according to Technical proposal 1, further comprising:
a controller,
a plurality of the sensor elements being provided,
the controller being configured to perform a first detection operation and a second detection operation,
in the first detection operation, the controller being configured to supply the first electric power in the first detection operation to the first conductive member included in one of the plurality of sensor elements, and to detect a first value corresponding to a difference between an electric resistance of the first resistance member included in the one of the plurality of sensor elements and an electric resistance of the second resistance member included in the one of the plurality of sensor elements, and
in the second detection operation, the controller being configured to supply the first electric power in the second detection operation to the first conductive member included in another one of the plurality of sensor elements, and to detect a second value corresponding to a difference between an electric resistance of the first resistance member included in the other one of the plurality of sensor elements and an electric resistance of the second resistance member included in the other one of the plurality of sensor elements.
   (Technical proposal 17)

The sensor according to Technical proposal 16, wherein
an electric resistance of the first conductive member included in the one of the plurality of sensor elements is different from an electric resistance of the first conductive member included in the other one of the plurality of sensor elements.
   (Technical proposal 18)

The sensor according to Technical proposal 16 or 17, wherein
the controller is configured to output a value obtained by calculation based on the first value and the second value.
   (Technical proposal 19)

The sensor according to Technical proposal 18, wherein
the value obtained by the calculation includes a value corresponding to each concentration of a plurality of types of detection target substances included in a detection target.
   (Technical proposal 20)

The sensor according to any one of Technical proposals 1-19, wherein
the first element includes:
   a first base region,
   a first fixed portion fixed to a part of the first base region, and
   a first support portion supported by the first fixed portion, the first support portion supporting the first detection section,
a first gap is provided between another part of the first base region and the first detection section,
the second element includes:
   a second base region,
   a second fixed portion fixed to a part of the second base region, and
   a second support portion supported by the second fixing portion, the second support portion supporting the second detection section, and
a second gap is provided between another part of the second base region and the second detection section.

According to the embodiment, a sensor capable of improving characteristics can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as, bases, detection sections, controller, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a sensor element including:
a first element including a first detection section, and
a second element including a second detection section,
the first detection section including a first resistance member and a first conductive member,
the second detection section including a second resistance member,
a second temperature of the first resistance member when a first electric power being supplied to the first conductive member being higher than a first temperature;
a second difference being smaller than a first difference,
the first difference being an absolute value of a difference between a first change rate of a first electrical resistance of the first resistance member with respect to temperature at the first temperature and a second change rate of a second electrical resistance of the second resistance member with respect to temperature at the first temperature, and
the second difference being an absolute value of a difference between a second temperature state change rate of the first electrical resistance of the first resistance member with respect to temperature at the second temperature and the second change rate.

2. The sensor according to claim 1, wherein
a first electrical resistance value of the first resistance member at the first temperature is different from a second electrical resistance value of the second resistance member at the first temperature.

3. The sensor according to claim 2, wherein
the second electrical resistance value is lower than the first electrical resistance value.

4. The sensor according to claim 2, wherein
the second electrical resistance value is not less than 0.3 times and not more than 0.95 times the first electrical resistance value.

5. The sensor according to claim 2, wherein
the first electrical resistance value is not less than 6 kΩ and not more than 12 kΩ, and
the second electrical resistance value is not less than 1.8 kΩ and not more than 12 kΩ.

6. The sensor according to claim 1, wherein
the first temperature is not less than −10° C. and not more than 80° C., and
an absolute value of a difference between the second temperature and the first temperature is not less than 30° C. and not more than 300° C.

7. The sensor according to claim 1, wherein
a ratio of an absolute value of a difference between the second difference and the first difference to the first difference is 0.5 or more.

8. The sensor according to claim 1, wherein
the second detection section further includes a second conductive member.

9. The sensor according to claim 1, further comprising:
a controller,
the controller being configured to perform a first operation,
in the first operation, the controller being configured to supply the first electric power to the first conductive member,
in the first operation, the controller being configured to detect a difference between a first detection value of the first electrical resistance of the first resistance member in the first operation and a second detection value of the second electrical resistance of the second resistance member in the first operation, and
the first detection value being configured to correspond to a detection target around the first detection section.

10. The sensor according to claim 1, wherein
at least one of the first resistance member or the second resistance member includes TiN.

11. The sensor according to claim 1, wherein
the first resistance member and the second resistance member satisfy at least one of a first condition, a second condition, or a third condition,
in the first condition, a first length of the first resistance member is different from a second length of the second resistance member,
in the second condition, a first width of the first resistance member is different from a second width of the second resistance member, and
in the third condition, a first thickness of the first resistance member is different from a second thickness of the second resistance member.

12. The sensor according to claim 11, wherein
in the first condition, the first length is longer than the second length,
in the second condition, the first width is smaller than the second width, and
in the third condition, the first thickness is smaller than the second thickness.

13. The sensor according to claim 1, wherein
the sensor element further includes a third element including a third detection section,
the third detection section includes a third resistance member,
a third temperature of the first resistance member when a second electric power is supplied to the first conductive member is higher than the first temperature,
a fourth difference is smaller than a third difference,
the third difference is an absolute value of a difference between the first change rate and a third change rate of a third electrical resistance of the third resistance member at the first temperature with respect to temperature, and
the fourth difference is an absolute value of a difference between a third temperature state change rate of the first electrical resistance of the first resistance member with respect to temperature at the third temperature and the third change rate.

14. The sensor according to claim 13, wherein
a first electrical resistance value of the first resistance member at the first temperature is different from a second electrical resistance value of the second resistance member at the first temperature,
the first electrical resistance value is different from a third electrical resistance value of the third resistance member at the first temperature, and
the second electrical resistance value is different from the third electrical resistance value.

15. The sensor according to claim 13, further comprising:
a controller,
the controller being configured to perform at least one of a first operation or a second operation,
in the first operation, the controller being configured to supply the first electric power to the first conductive member,
in the first operation, the controller being configured to detect a difference between a first detection value of the first electrical resistance of the first resistance member in the first operation and a second detection value of the second electrical resistance of the second resistance member in the first operation,
the first detection value being configured to correspond to a detection target around the first detection section,
in the second operation, the controller being configured to supply the second electric power to the first conductive member, and
in the second operation, the controller being configured to detect a difference between the first detection value of the first electrical resistance of the first resistance member in the second operation and a third detection value of the third electrical resistance of the third resistance member in the second operation.

16. The sensor according to claim 1, further comprising:
a controller,
a plurality of the sensor elements being provided,
the controller being configured to perform a first detection operation and a second detection operation,
in the first detection operation, the controller being configured to supply the first electric power in the first detection operation to the first conductive member included in one of the plurality of sensor elements, and to detect a first value corresponding to a difference between an electric resistance of the first resistance member included in the one of the plurality of sensor elements and an electric resistance of the second resistance member included in the one of the plurality of sensor elements, and
in the second detection operation, the controller being configured to supply the first electric power in the second detection operation to the first conductive member included in another one of the plurality of sensor elements, and to detect a second value corresponding to a difference between an electric resistance of the first resistance member included in the other one of the plurality of sensor elements and an electric resistance of the second resistance member included in the other one of the plurality of sensor elements.

17. The sensor according to claim 16, wherein
an electric resistance of the first conductive member included in the one of the plurality of sensor elements is different from an electric resistance of the first conductive member included in the other one of the plurality of sensor elements.

18. The sensor according to claim 16, wherein
the controller is configured to output a value obtained by calculation based on the first value and the second value.

19. The sensor according to claim 18, wherein
the value obtained by the calculation includes a value corresponding to each concentration of a plurality of types of detection target substances included in a detection target.

20. The sensor according to claim 1, wherein
the first element includes:
a first base region,
a first fixed portion fixed to a part of the first base region, and
a first support portion supported by the first fixed portion, the first support portion supporting the first detection section,
a first gap is provided between another part of the first base region and the first detection section,
the second element includes:
a second base region,
a second fixed portion fixed to a part of the second base region, and
a second support portion supported by the second fixing portion, the second support portion supporting the second detection section, and
a second gap is provided between another part of the second base region and the second detection section.
